(19) United States
(12) Patent Application Publication
(10) Pub. No.: US 2001/0042712 A1
(43) Pub. Date: Nov. 22, 2001

(54) Microfluidic concentration gradient loop

(76) Inventors: C. Frederick Battrell, Redmond, WA (US); Ronald L. Bardell, Redmond, WA (US); Gerald L. Klein, Edmonds, WA (US)

Correspondence Address: JERROLD J. LITZINGER, SENTRON MEDICAL, INC., 4445 LAKE FOREST DR., SUITE 600, CINCINNATI, OH, 45242, US

(21) Appl. No.: 09/863,674

(22) Filed: May 23, 2001

Related U.S. Application Data
(60) Provisional application No. 60/206,878, filed on May 24, 2000.

(51) Int. Cl. B01D 11/00

(52) U.S. Cl. 210/511; 210/96.1; 422/69; 422/100

(57) ABSTRACT

A device for generating a stable concentration gradient in a microfluidic channel. A solution of a given concentration of a soluble compound and a diluting solution are co-delivered into a microfluidic channel. By varying the flow rates of the two solutions, the concentration of the soluble compound can be varied as a function of the length of the channel.

### CROSS REFERENCE TO RELATED APPLICATIONS

This application claims benefit from U.S. Provisional patent appplication Ser. No. 60/201,878, filed May 24, 2000, which application is incorporated herein by reference.

### BACKGROUND OF THE INVENTION

1. Field of the Invention

This invention relates generally to microfluidic devices for performing analytic testing, and, in particular, to a device and method for generating a stable concentration gradient in a microfluidic channel by varying the flow rate of the solutions flowing within the channel.

2. Description of the Related Art

Microfluidic devices have recently become popular for performing analytic testing. Using tools developed by the semiconductor industry to miniaturize electronics, it has become possible to fabricate intricate fluid systems which can be inexpensively means produced. Systems have been developed to perform a variety of analytical techniques for the acquisition of information for the medical field.

U.S. Pat. No. 5,716,852 teaches a method for analyzing the presence and concentration of small particles in a flow cell using diffusion principles. This patent, the disclosure of which is incorporated herein by reference, discloses a channel cell system for detecting the presence of analyte particles in a sample stream using a laminar flow channel having at least two inlet means which provide an indicator stream and a sample stream, where the laminar flow channel has a depth sufficiently small to allow laminar flow of the streams and length sufficient to allow diffusion of particles of the analyte into the indicator stream to form a detection area, and having an outlet out of the channel to form a single mixed stream. This device, which is known at a T-Sensor, may contain an external detecting means for detecting changes in the indicator stream. This detecting means may be provided by any means known in the art, including optical means such as optical spectroscopy, or absorption spectroscopy of fluorescence.

U.S. Pat. No. 5,932,100, which patent is also incorporated herein by reference, teaches another method for analyzing particles within microfluidic channels using diffusion principles. A mixture of particles suspended in a sample stream enters an extraction channel from one upper arm of a structure, which comprises microchannels in the shape of an “H”. An extraction stream (a dilution stream) enters from the lower arm on the same side of the extraction channel and due to the size of the microfluidic extraction channel, the flow is laminar and the streams do not mix. The sample stream exits as a by-product stream at the upper arm at the end of the extraction channel, while the extraction stream exits as a product stream at the lower arm. While the streams are in parallel laminar flow is in the extraction channel, particles having a greater diffusion coefficient (smaller particles such as albumin, sugars, and small ions) have time to diffuse into the extraction stream, while the larger particles (blood cells) remain in the sample stream. Particles in the exiting extraction stream (now called the product stream) may be analyzed without interference from the larger particles. This microfluidic structure, commonly known as an “H-Filter,” can be used for extracting desired particles from a sample stream containing those particles.

These microfluidic devices use diffusion principles to perform many differential analyses within flowing microchannels. However, it is often helpful to perform a real time analysis on a flowing suspension of substances to determine a reaction of certain compounds across a detection zone. An example of this type of device is described in U.S. Pat. No. 6,096,509, which issued on Aug. 1, 2000. This patent describes an apparatus and method for real time measurement of a cellular response of a test compound or series of test compounds on a flowing suspension of cells. A homogeneous suspension of each member of a series of cell types is combined with a concentration of a test compound which is directed through a detection zone to measure in real time the cellular response as the cells in the test mixture flow through the detection zone.

### SUMMARY OF THE INVENTION

It is therefore an object of the present invention to provide a device for generating a stable concentration gradient within a microfluidic channel.

It is a further object of the present invention to provide a microfluidic structure in which the flow rates can be varied such that the concentration of a solution compound can be varied as a function of the length of the channel.

It is a still further object of the present invention to provide a system for providing parallel processing of concentration gradient microchannels useful for drug discovery systems.

These and other objects of the present invention will be more readily apparent from the description and drawings that follow.

### BRIEF DESCRIPTION OF THE DRAWINGS

FIG. 1 is an illustration of the fluid flow through the microfluidic flow channel of a T-Sensor;

FIG. 2 is a cross-sectional view of a section of the flow channel used in the present invention;

FIG. 3 is a top view of a section of the flow channel of the present invention showing diffusion across the channel;

FIG. 4 is a view of the channel shown in FIG. 3 after some time has elapsed;

FIG. 5 is a three-dimensional graph showing diffusion of material in the longitudinal channel direction after one hour;

FIG. 6 is a three-dimensional graph showing diffusion of material in the longitudinal channel direction after one month;

FIG. 7 is a representation of an integrated microfluidic circuit using the principles of the present invention;

FIG. 8 is a representation of a device for processing parallel microfluidic channels using the principles of the present invention;

FIG. 9 is a view of a section of a channel showing a concentration gradient created by a change in the rate of flow of a solution into the channel; and

FIG. 10 is a view of a section of channel, similar to FIG. 9, showing a concentration gradient created by a periodic change of the rate of flow a solution into the channel.

### DESCRIPTION OF THE PREFERRED EMBODIMENTS

Referring now to FIG. 1, there is shown a T-Sensor generally indicated at 10. The principles of operation of T-Sensor 10 are discussed in detail in U.S. Pat. No. 5,716,852. T-Sensor 10 consists of a sample stream inlet port 12, a sample stream channel 14, an indicator stream port 16, and an indicator stream channel 18. Sample stream channel 14 meets indicator stream channel 18 at T-joint 20 at the beginning of flow channel 22. When a liquid sample is introduced into each of ports 12, 16, a pair of streams 24, 26 flow through channels 14, 18 and into flow channel 22. Streams 24, 26 move in parallel laminar flow within channel 22 due to the low Reynolds number in channel 22, as no turbulence mixing occurs. Flow channel 22 exits into an outlet port 28. The flow rates from ports 12 and 16 are constant; both streams 24 and 26 flow at the same rate within its channel without changing. The only mixing that occurs within channel 22 is due to diffusion across the laminar boundary between streams 24 and 26 by smaller particles from sample stream 24. If diffusion within T-Sensor 10 has reached equilibrium, and the flow rate from port 12 is constant and the flow rate from port 16 is constant, channel 22 will then contain a uniform solution, and there is no change in concentration along the length of channel 22.

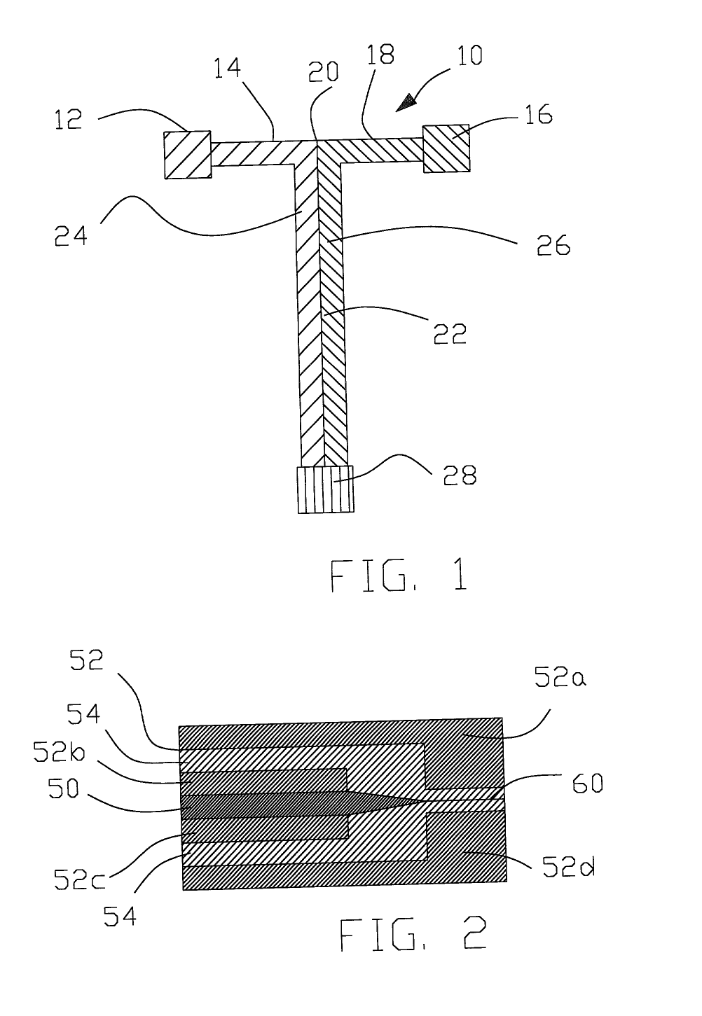

The formation of a concentration gradient across a microfluidic channel can be seen in FIGS. 2-4. Referring now to FIG. 2, a first solution 50 containing a given concentration of soluble compounds is introduced into a microfluidic channel 52 containing layers 52a-d. In the present embodiment, solution 50 is injected into channel 52, between layers 52b and 52c. A diluting solution 54 is also introduced into channel 52. Solution 54 is introduced in two sections in the present embodiment, between layers 52a and 52b, and also between layers 52c and 52d. As solution 54 contacts solution 50 on both sides of the stream, solution 50 containing the soluble compounds forms a thin ribbon 60, which is uniformly distributed across the width of channel 52.

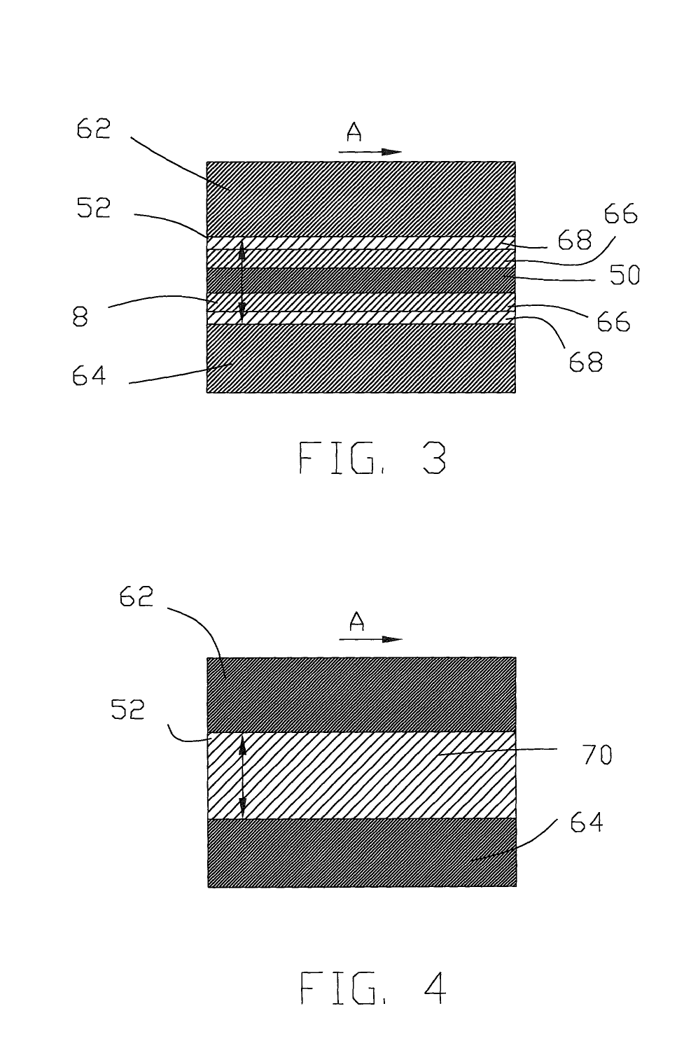

FIGS. 3 and 4 show the diffusion characteristics of the present embodiment across channel 52. Referring now to FIG. 3, there is shown a top view of channel 52 showing the diffusion across channel 52 at time X, where the combined solutions are flowing within channel 52 in the direction indicated by arrow A. Particles from solution 50 have begun to diffuse towards walls 62 and 64 of channel 52, forming a pair of regions 66 on either side of solution 50, and a second pair of regions 68 near walls 62 and 64 of channel 52. FIG. 4, which shows channel 52 at time Xᵢ₊₁, shows a uniform solution 70 across channel 52 with the solution flowing in the direction of arrow A, indicating that rapid diffusion has taken place within in a few seconds across the width direction.

It is often desirable to establish a stable concentration gradient along the length of the main channel in a microfluidic device. This concentration can be used to efficiently measure the effect on concentration on biological or chemical materials. The creation of a stable concentration gradient is initiated by a change in the flow rate in either the solution containing the soluble compounds or the diluting solution, or both. By changing the ratio of the flow rates of these solutions, the concentration of the soluble compound within the channel can be varied as a function of the length of the channel.

Examples of a concentration gradient within a channel can be seen in FIG. 9. Referring now to FIG. 9, there is seen microfluidic channel 52 from FIG. 2 at a location spaced downstream, in which the ratio of the flow rates of solutions 50 and 54 is not constant. It can be seen that a concentration gradient has been generated at 80 within channel 52. Thus, while diffusion in the width direction in channel 52 occurs within seconds, diffusion in the length direction of the channel takes a very long time.

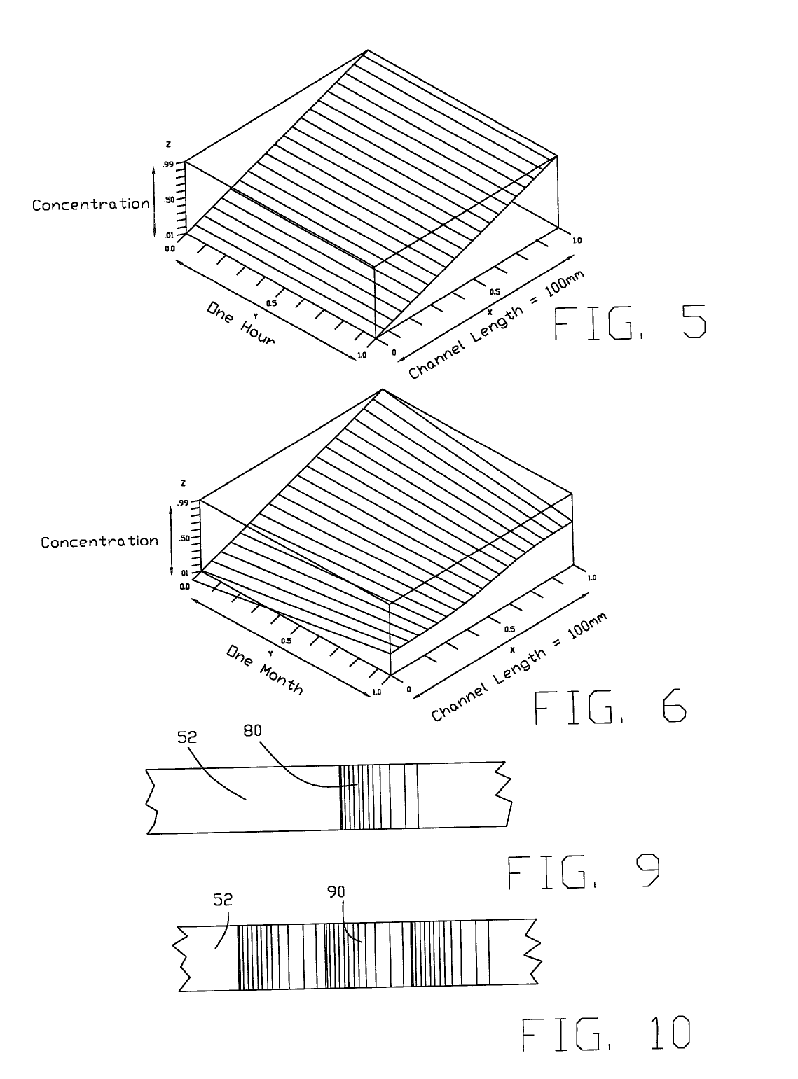

FIG. 5 depicts a graph showing the diffusion of material, 500 MW, along the channel length of 100 mm. As can be seen from the graph, the concentration has essentially stabilized over a one-hour time period, showing that the concentration gradient is very stable in the longitudinal direction of channel 52. In addition, FIG. 6 depicts the concentration along the length of the 100 mm channel over the course of one month (720 hours). It can be seen in this graph that there is very little change over this long time period, proving that the concentration gradient of the present invention is very stable.

FIG. 10 shows an example of the channel of FIG. 9 in which the ratio of the flow rates between the solutions. Referring now to FIG. 10, there is seen microfluidic channel 52 at a location spaced downstream from the location shown in FIG. 2 when the ratio between the flow rates of the two input solutions is varying periodically, such as sinusoidally. The concentration gradient as shown at 90 in channel 52 varies sinusoidally.

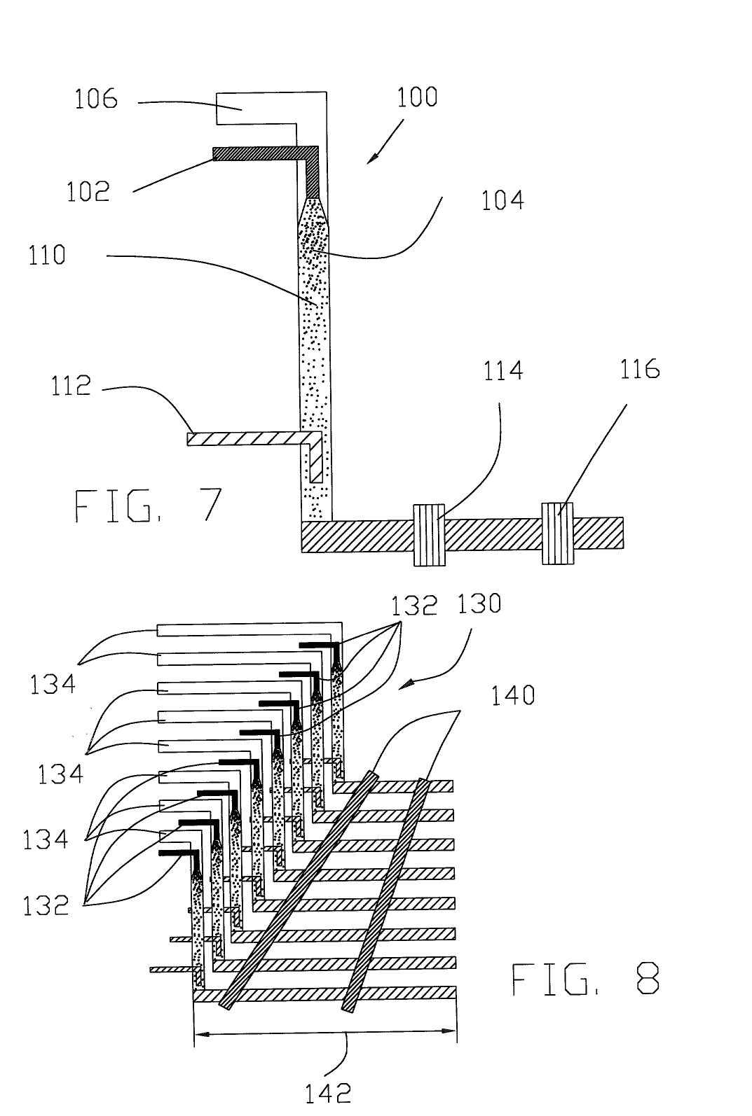

An integrated microfluidic circuit for analyzing samples using a stable concentration gradient is shown in FIG. 7. Referring now to FIG. 7, there is shown a circuit, generally designated as 100, based on the principles of the present invention. A solution 102 containing soluble compounds is injected into a main channel 104 into a layer of a diluting solution 106, as shown in FIG. 2. The flow rates of either solution 106 and/or solution 102 are varied in order to establish a concentration gradient, which can be seen at 110 in channel 104. A biological material 112 is injected into channel 104 into the concentration gradient. Material 112 may consist of cells or proteins, or it may consist of reactive beads or other chemical material. Material 112 flows within channel 104 and can interact with the concentration gradient, where it may be detected at a first measurement zone 114 or at a second measurement zone 116, which could preferably detect a difference between the measurements at zone 114.

The principles of circuit 100 shown in FIG. 7 can be applied to a parallel processing system of concentration gradient microchannels which could be used as a drug discovery system. Referring now to FIG. 8, there is shown a system, generally designated at 130, which contains a plurality of parallel microchannels 132 in which soluble compounds are injected into diluting solution streams 134 all in parallel. Further downstream in channels 132 where a concentration gradient has been established, a biological or chemical material 136 is injected into each channel, and a pair of sensors 140 monitor the binding or inhibition of binding within an interaction zone 142 to determine the effect on the particular cell or proteins contained within channels 132. This particular embodiment is easily adaptable to drug discovery systems which use a microliter format (8×10), and can be manufactured on a single chip.

While the present invention has been shown and described in terms of several preferred embodiments thereof, it will be understood that this invention is not limited to these particular embodiments and that many changes and modifications may be made without departing from the true spirit and scope of the invention as defined in the appended claims.

What is claimed is:

1. A microfluidic device for providing a concentration gradient, comprising:
a microfluidic channel having a first and second inlet and a first outlet;
a first fluid comprising a diffusible constituent flowing through said first inlet into said channel;
a second fluid flowing through said second inlet into said channel such that said first fluid flows in parallel with said second channel in at least a portion of said channel, thereby providing a diffusion interface between said first and said second fluid and said diffusible constituent diffuses from said first fluid into said second fluid such that the concentration of diffusible species varies along the longitudinal axis of said diffusion interface.

2. The device of claim 1, wherein said second fluid comprises particles that interact with said diffusible constituent of said first fluid such that the interaction creates a measurable effect that is different for different concentrations of diffusible species.

3. The device of claim 1, further comprising:
a third fluid inlet to said channel and a third fluid also comprising diffusible constituents entering said channel through said third inlet such that said first and third fluids, surround said second fluid on two sides and diffusible constituents diffuse into said second fluid, thus diluting said second fluid such that the concentration of said second fluid is gradually decreased with distance from a section of said channel where said first and second fluids contact one another.

4. The device of claim 4, wherein said first and third fluids are introduced through said first and third inlet from a common inlet.

5. A microfluidic device for exposing particles to a concentration gradient comprising:
a first inlet and a first solution;
a second inlet and a second solution also comprising a first soluble compound;
a first channel, attached to said first and second inlets, with
said first and second solutions flowing in parallel with each other through said first channel, thereby mixing by diffusion and thus forming
a stream having a gradient of concentration along the longitudinal axis of said first channel;
and a third inlet, located downstream from said first and second inlets and a third solution flowing within said third inlet containing particulate matter such that said third solution and said stream flow in parallel in the portion of said channel located downstream from said third inlet, whereby exposing said particulate matter to a concentration gradient.

6. The device of claim 5, wherein a plurality of said microfluidic devices are located on a single chip.

7. The device of claim 6, further comprising a measurement region for measuring the difference in a response within said devices on said chip.

8. The device of claim 1, wherein the rate of flow of said first fluid and said second fluid remain constant.

9. The device of claim 1, wherein the rate of flow of said first fluid varies with respect to the rate of flow of said second fluid.

10. The device of claim 1, wherein said diffusible constituent consists of a soluble compound.

11. The device of claim 5, wherein said particulate matter comprises biological material.

12. The device of claim 11, wherein said biological matter consists of cells.

13. The device of claim 11, wherein said biological material consists of proteins.

14. The device of claim 5, further comprising sensing means for measuring a reaction between said stream and said particulate matter in said third solution.

15. The device of claim 2, wherein said particles consist of molecules such as proteins.

16. The device of claim 2, wherein said particles consist of large undissolved particles.

17. The device of claim 17, wherein said undissolved particles consist of microbeads.
